(19) United States
(12) Patent Application Publication
(10) Pub. No.: US 2014/0368180 A1
(43) Pub. Date: Dec. 18, 2014

(54) REFERENCE VOLTAGE GENERATOR AND VOLTAGE GENERATING SYSTEM HAVING THE SAME

(71) Applicant: SK hynix Inc., Gyeonggi-do (KR)

(72) Inventor: Seung-Han OK, Gyeonggi-do (KR)

(73) Assignee: SK hynix Inc., Gyeonggi-do (KR)

(21) Appl. No.: 14/046,599

(22) Filed: Oct. 4, 2013

(30) Foreign Application Priority Data
Jun. 14, 2013 (KR) 10-2013-0068439

(51) Int. Cl. G05F 3/26

(52) U.S. Cl. CPC G05F 3/262
USPC 323/315

(57) ABSTRACT

A reference voltage generator includes a constant voltage generator suitable for using a high voltage as a first power supply voltage and for generating a constant voltage, and a first reference voltage generating unit suitable for using the constant voltage as a second power supply voltage and for generating a first reference voltage.

### CROSS-REFERENCE TO RELATED APPLICATIONS

The present application claims priority of Korean Patent. Application No. 10-2013-0068439, filed on Jun. 14, 2013, which is incorporated herein by reference in its entirety.

### BACKGROUND

1. Field

Exemplary embodiments of the present invention relate to a reference voltage generator and a voltage generating system having the same, and more particularly, to a reference voltage generator and a voltage generating system having the same for generating a reference voltage using a high voltage, which is higher than a memory chip driving voltage (VCC or VDD), as a power supply voltage of a reference voltage generating circuit.

2. Description of the Related Art

Various internal voltages may be used in a semiconductor device, and an analog circuit may be used in generating the various internal voltages. Since the analog circuit uses a lot of series transistors, a minimum power supply voltage for a normal operation is requested to have a high value, and a using voltage of the semiconductor device is requested to be lowered.

Generally, a reference voltage generating unit includes a widlar type first reference voltage generating unit, a regulator, and a widlar type second reference voltage generating unit. The widlar type first reference voltage uses an external voltage as a power supply voltage, and generates a first reference voltage. The regulator uses the external voltage as the power supply voltage generates an intermediate voltage using the first reference voltage. The widlar type second reference voltage generates a second reference voltage using the intermediate voltage as the power supply voltage.

The intermediate voltage is necessary for improving the dependency of the external voltage. But, when a regulated internal voltage is used as a power supply voltage of a consecutive widlar type reference voltage generating unit, a minimum operation characteristic deterioration of a low voltage may occur.

### SUMMARY

In accordance with an embodiment of the present invention, a reference voltage generator may include a constant voltage generator suitable for using a high voltage as a first power supply voltage and for generating a constant voltage, and a first reference voltage generating unit suitable for using the constant voltage as a second power supply voltage and for generating a first reference voltage.

In accordance with an embodiment of the present invention, a reference voltage generator a constant current generator suitable for using a high voltage as a first power supply voltage and generating a constant current, and a first reference voltage generating unit suitable for using the constant current as a power source and generating a first reference voltage.

In accordance with an embodiment of the present invention, a voltage generating system includes may include a reference voltage generator including a constant voltage generator suitable for using a first high voltage as a first power supply voltage and generating a constant voltage and a first reference voltage generating unit suitable for using the constant voltage as a second power supply voltage and generating a first reference voltage, and a boosting unit suitable for generating a second high voltage in response to the first reference voltage and the second high voltage.

In accordance with an embodiment of the present invention, a voltage generating system may include a reference voltage generator including a constant current generator suitable for using a first high voltage as a power supply voltage and generating a constant current and a first reference voltage generating unit suitable for using the constant current as a power source and generating a first reference voltage, and a boosting unit suitable for generating a second high voltage in response to the first reference voltage and the second high voltage.

In accordance with an embodiment of the present invention, a voltage generating method includes generating a reference voltage, generating an oscillator enable signal by comparing the reference voltage with a high voltage, and generating the high voltage in response to the oscillator enable signal.

### BRIEF DESCRIPTION OF THE DRAWINGS

FIGS. 1A and 1B are block diagrams illustrating a voltage generating device in accordance with an embodiment of the present invention.

FIG. 2 is a block diagram illustrating a reference voltage generating unit shown in FIG. 1 in accordance with an embodiment of the present invention.

FIGS. 3A and 3B are circuit diagrams illustrating a first reference voltage generating unit shown in FIG. 2 in accordance with an embodiment of the present invention.

FIGS. 4A and 4B are circuit diagrams illustrating a regulator shown in FIG. 2 in accordance with an embodiment of the present invention.

FIG. 5 is a circuit diagram illustrating a second reference voltage generating unit shown in FIG. 2 in accordance with an embodiment of the present invention.

FIGS. 6A and 6B are circuit diagrams illustrating a reference voltage generating unit shown in FIG. 2 in accordance with another embodiment of the present invention.

FIG. 7 is a block diagram illustrating a reference voltage generating unit for generating two reference voltages in accordance with an embodiment of the present invention.

FIGS. 8A through 8C are circuit diagrams illustrating various embodiments of the present invention in a memory system including a controller and a memory device.

FIG. 9 is a block diagram illustrating an electronic system in accordance with an embodiment of the present invention.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, reference numerals correspond directly to the like numbered parts in the various figures and embodiments of the present invention. It is also noted that in this specification, “connected/coupled” refers to one component not only directly coupling another component but also indirectly coupling another component through an intermediate component. In addition, a singular form may include a plural form as long as it is not specifically mentioned in a sentence.

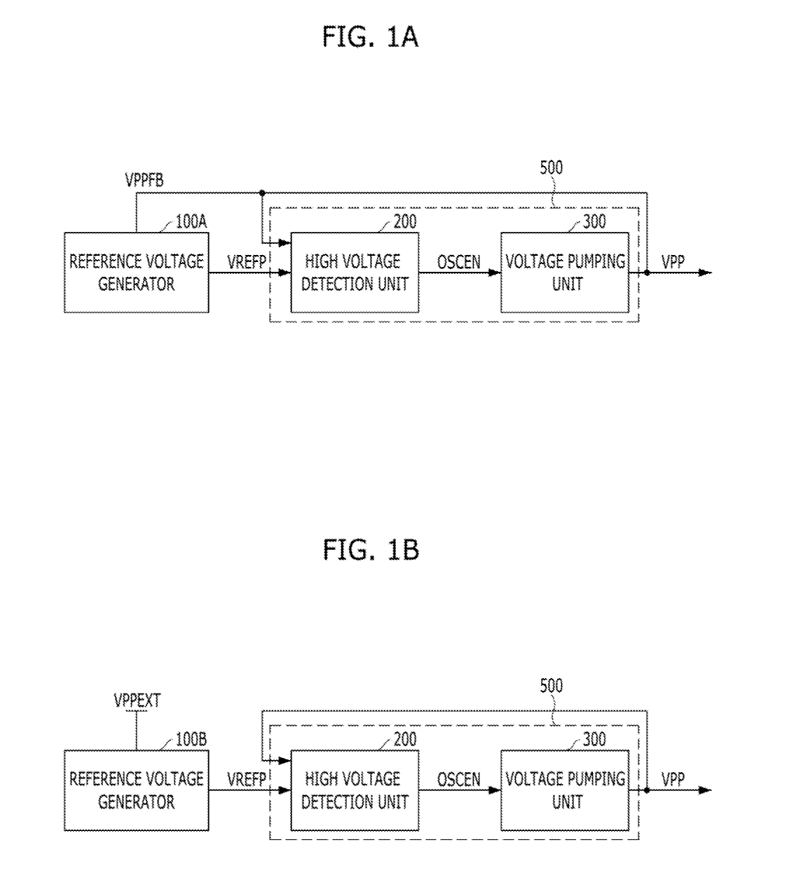

FIGS. 1A and 1B are block diagrams illustrating a voltage generating device in accordance with an embodiment of the present invention.

Referring to FIG. 1A, a voltage generating device in accordance with an embodiment of the present invention includes a reference voltage generating unit 100A for generating a reference voltage VREFP, a boosting unit 500, which includes a high voltage detection unit 200 for comparing the reference voltage VREFP with a high voltage VPPFB and generating an oscillator enable signal OSCEN based on a comparison result, and a voltage pumping unit 300 for generating a high voltage VPP in response to the oscillator enable signal OSCEN.

The boosting unit 500 is well known in this art and may generate the high voltage VPP by other methods and circuits.

The reference voltage generating unit 100A includes a first reference voltage generating unit 110, a regulator 120 and a second reference voltage generating unit 130.

Referring to FIG. 1B, a voltage generating device in accordance with another embodiment of the present invention includes a reference voltage generating unit 1008 for inputting an external high voltage VPPEXT and generating a reference voltage VREFP, a boosting unit 500, which includes a high voltage detection unit 200 for comparing the reference voltage VREFP with a high voltage VPP and generating an oscillator enable signal OSCEN based on a comparison result, and a voltage pumping unit 300 for generating a high voltage VPP in response to the oscillator enable signal OSCEN.

The external high voltage VPPEXT is a voltage substantially corresponding to the output voltage VPP of the boosting unit 500.

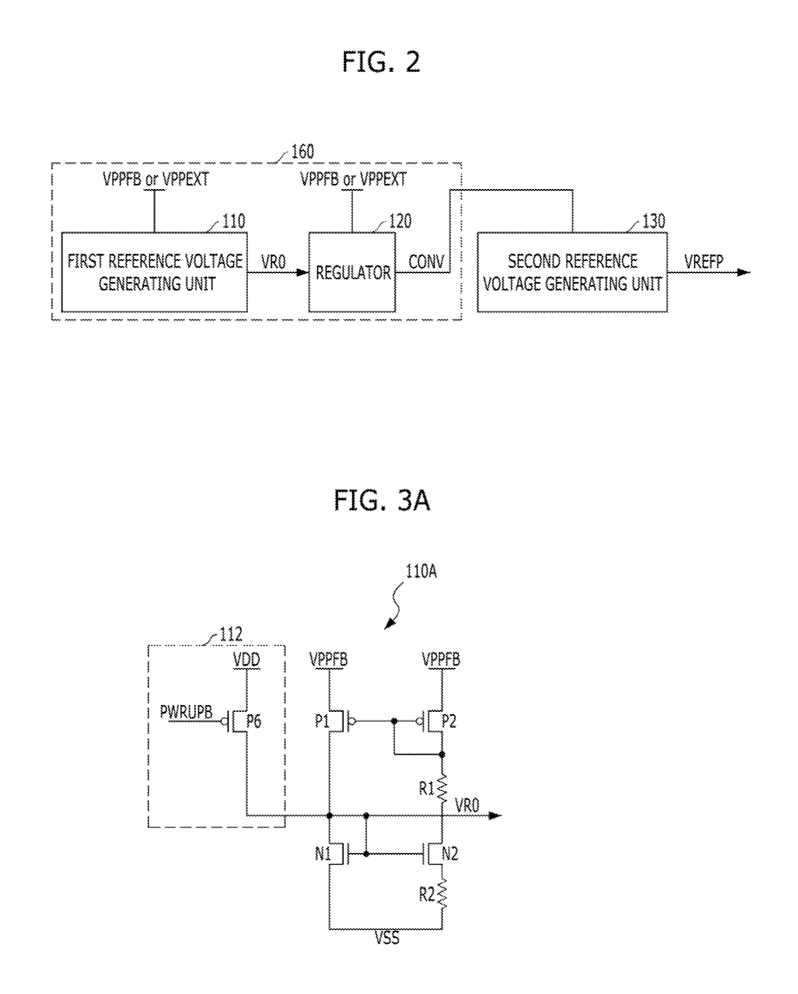

FIG. 2 is a block diagram illustrating a reference voltage generating unit shown in FIG. 1 in accordance with an embodiment of the present invention.

Referring to FIG. 2, the reference voltage generator 100A or 100B includes a constant voltage generator 160 suitable for inputting the high voltage VPPFB or VPPEXT and for generating a constant voltage CONV, and a second reference voltage generating unit 130. The constant voltage generator 160 includes a first reference voltage generating unit 110 and a regulator 120. The first reference voltage generating unit 110 inputs the high voltage VPPFB or VPPEXT as a power supply voltage and generates a first reference voltage VR0, The regulator 120 uses the high voltage VPPFB or VPPEXT as the power supply voltage and generates a constant voltage CONV by regulating the high voltage VPPFB or VPPEXT in response to the first reference voltage VR0. The second reference voltage generating unit 130 uses the constant voltage CONV as the power supply voltage and generates a second reference voltage as the reference voltage VREFP.

Herein, the constant voltage CONV, which is regulated by the regulator 120, is used to prevent a swing of an internal voltage caused by a noise. The constant voltage CONV may be used as an operation voltage of a reference voltage generator, a detector and an amplifier. Herein, the high voltage VPP may be provided to the first reference voltage generating unit 110 by a reinforced pumping manner using a power-up signal at a power-up start.

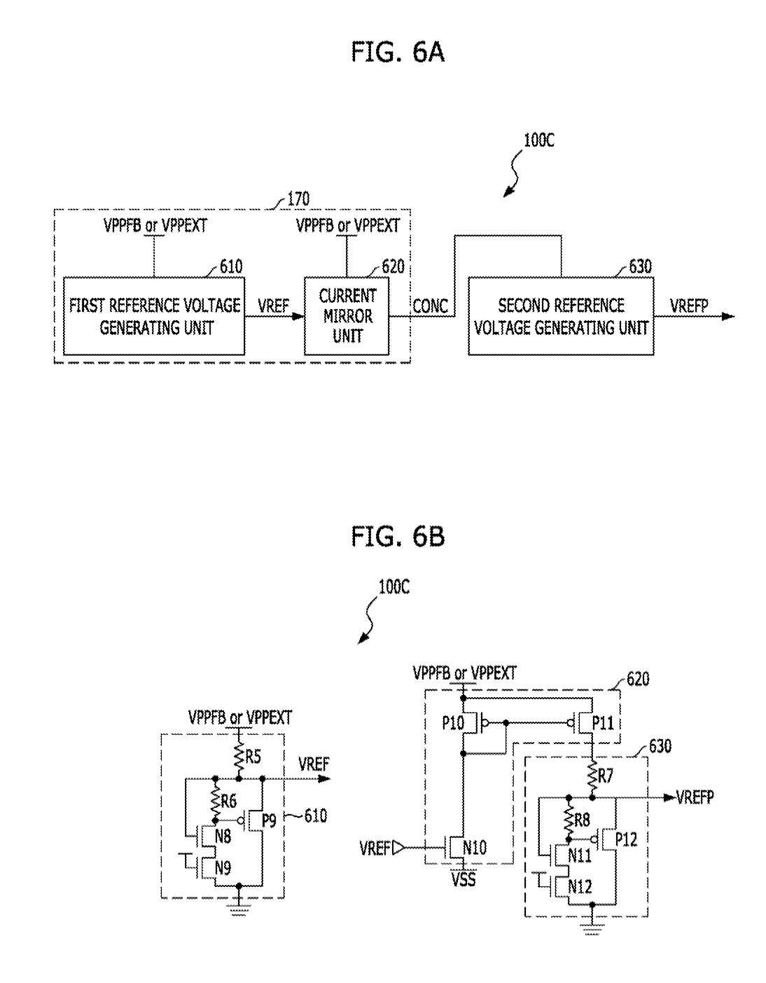

Meanwhile, in another embodiment, the reference voltage generating unit 100 may have a threshold type reference voltage. The detailed description of the reference voltage generating unit 100 in accordance with another embodiment of the present invention will be described with reference to FIGS. 6A and 6B.

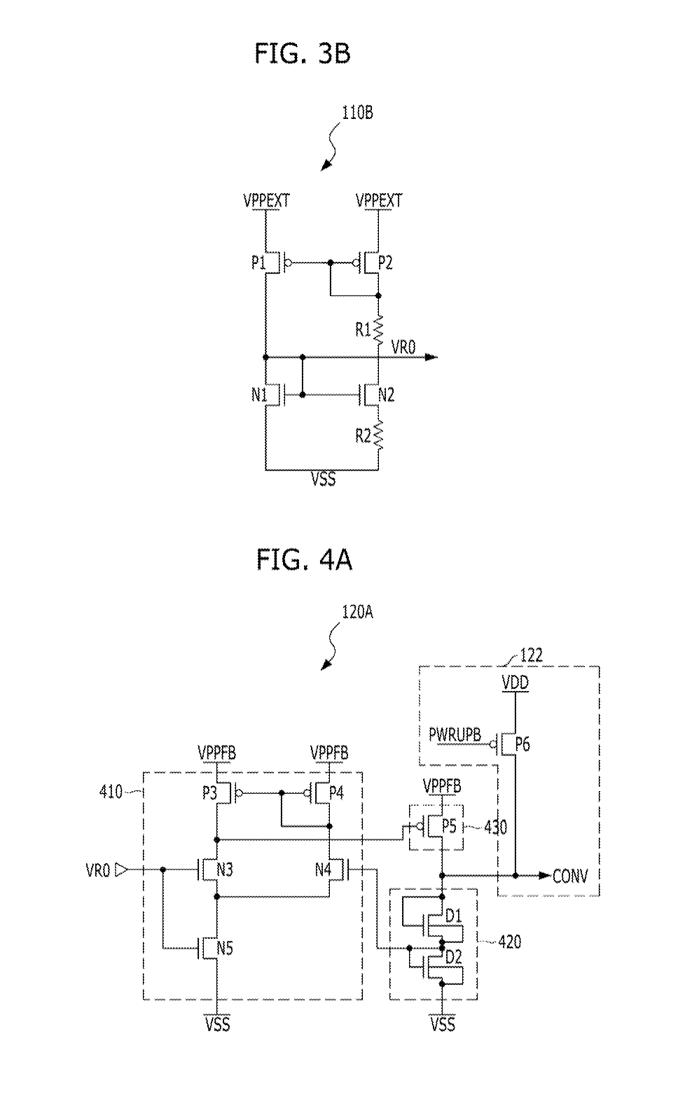

FIGS. 3A and 3B are circuit diagrams illustrating a first reference voltage generating unit shown in FIG. 2 in accordance with an embodiment of the present invention.

The first reference voltage generating unit 110A of FIG. 3A corresponds to a case that uses the high voltage VPPFB as the power supply voltage, that is, feedback voltage from the boosting unit 500. The first reference voltage generating unit 110B of FIG. 3B corresponds to a case that uses the external high voltage VPPEXT as the power supply voltage.

Referring to FIG. 3A the first reference voltage generating unit 110A may comprise an initial power supplier 112, which includes a sixth PMOS transistor P6, and may include a first PMOS transistor P1, a second PMOS transistor P2, a first NMOS transistor N1, a second NMOS transistor N2, a first resistor R1 and a second resistor R2.

The initial power supplier 112 may supply a stabilized initial power-up start in the first reference voltage generating unit 110A. The initial power supplier 112 may include the sixth PMOS transistor of which source is connected to an external voltage VDD and gate is connected to an initial power-up signal line PWRUPB and drain is coupled to a drain of the first PMOS transistor P1 and a drain of the first NMOS transistor N1. The first PMOS transistor P1 and the second PMOS transistor P2 are coupled to a power supply voltage terminal, which provides the high voltage VPPFB, respectively. A gate of the first PMOS transistor P1 and a gate of the second PMOS transistor P2 are commonly coupled to a drain of the second PMOS transistor P2. A gate and the drain of the first NMOS transistor N1 is commonly coupled to the drain of the first PMOS transistor P1 and an output voltage VR0 terminal and the drain of the sixth PMOS transistor. A source of the first NMOS transistor N1 is coupled to a ground voltage VSS terminal. A gate of the second NMOS transistor N2 is commonly coupled to a gate of the first NMOS transistor. The first resistor R1 is coupled between the second PMOS transistor P2 and the second NMOS transistor N2. The second resistor R2 is coupled between the second NMOS transistor N2 and the ground voltage VSS terminal.

Herein, the first reference voltage generating unit 110A may use a widlar type reference voltage generator.

Generally, a reference voltage generator may output a uniform voltage level of an internal voltage, which is not sensitive to a noise of a power supply voltage irrespective of a change of temperature.

Referring to FIG. 3B, the first reference voltage generating unit 110B is the same as that of FIG. 3A, except that it does not need the initial power supplier 112 and uses the external high voltage VPPEXT as the power supply voltage.

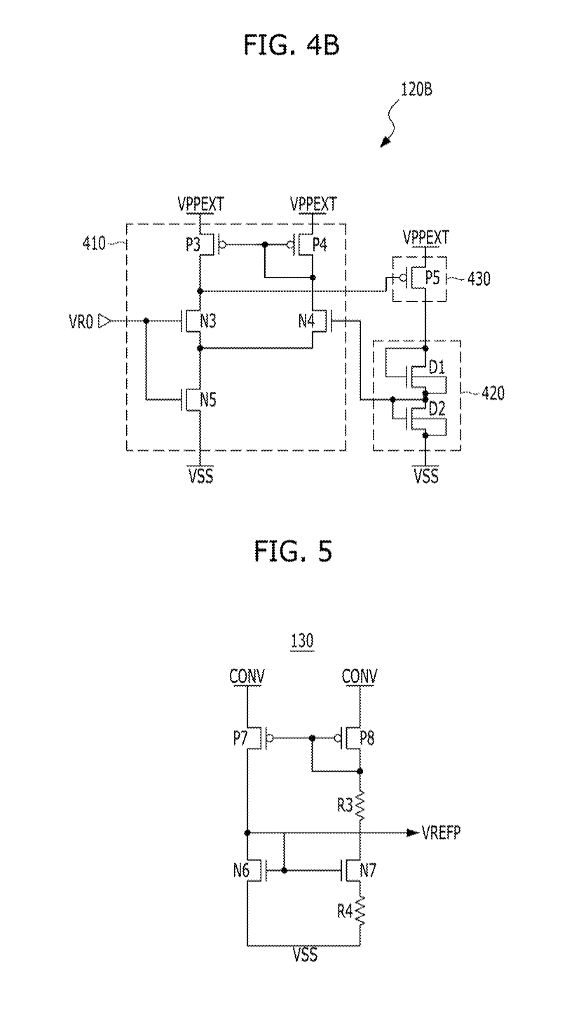

FIGS. 4A and 4B are circuit diagrams illustrating a regulator shown in FIG. 2 in accordance with an embodiment of the present invention.

The regulator 120A of FIG. 4A corresponds to a case that uses the high voltage VPPFB as the power supply voltage, that is, feedback voltage from the boosting unit 500. The regulator 1208 of FIG. 4B corresponds to a case that uses the external high voltage VPPEXT as the power supply voltage.

As shown in FIG. 4A, the regulator 120 includes a differential amplifying unit 410, a voltage dividing unit 420, a current providing unit 430 and an initial power supplier 122 explained in FIG. 3A.

The differential amplifying unit 410 includes a third PMOS transistor P3, a fourth PMOS transistor P4, a third NMOS transistor N3, a fourth NMOS transistor N4 and a fifth NMOS transistor N5.

A source of the third PMOS transistor P3 and the fourth PMOS transistor P4 is coupled to a power supply voltage terminal, which supplies the high voltage VPPFB. A gate of the third PMOS transistor P3 and a gate of the fourth PMOS transistor P4 are commonly coupled to a drain of the fourth PMOS transistor P4. A drain of the third NMOS transistor N3 is coupled to the drain of the third PMOS transistor P3. A drain of the fourth NMOS transistor N4 is coupled to the drain of the fourth PMOS transistor P4. A source of the third NMOS transistor N3 and a source of the fourth NMOS transistor N4 are commonly coupled to a drain of the fifth NMOS transistor N5. A source of the fifth NMOS transistor N5 is coupled to a ground voltage VSS terminal. A gate of the third NMOS transistor N3 and a gate of the fifth NMOS transistor N5 receive the first reference voltage VR0 outputted from the first reference voltage generating unit 110. A gate of the fourth NMOS transistor N4 is coupled to the voltage dividing unit 420.

The differential amplifying unit 410 receives differentially a divided voltage from the voltage driving unit 420 and the first reference voltage VR0 outputted from the first reference voltage generating unit 110, and outputs a determined voltage level to the current providing unit 430. The divided voltage may be a half of the constant voltage.

The voltage dividing unit 420 includes a first diode D1 and a second diode D2, and divides a voltage. The divided voltage is outputted to the differential amplifying unit 410.

The current providing unit 430 includes a fifth PMOS transistor P5, and outputs a constant voltage CONV in response to the determined voltage level of the differential amplifying unit 410.

That is, the regulator 120A receives the first reference voltage VR0 outputted from the first reference voltage generating unit 110, regulates the high voltage VPPFB, and generates the constant voltage CONV. Herein, since a swing of an internal voltage may occur due to a noise in case of the high voltage VPPFB, the constant voltage CONV, which is regulated, instead of the high voltage VPPFB is used in preventing the swing of the internal voltage.

Especially, when an initial internal voltage is generated, an external voltage VDD is used as the initial internal voltage. After the initial internal voltage is generated, if the high voltage VPPFB reaches a stable voltage level, the constant voltage CONV is used. For such an operation, a sixth PMOS transistor P6 is additionally disposed. The sixth PMOS transistor P6 outputs the external voltage VDD during a power-up start and outputs the constant voltage CONV after a predetermined time in response to a power-up signal PWRUPB.

Referring to FIG. 4B, the regulator 1206 is the same as that of FIG. 4A, except that it does not need the initial power supplier 122 and uses the external high voltage VPPEXT as the power supply voltage.

FIG. 5 is a circuit diagram illustrating a second reference voltage generating unit shown in FIG. 2 in accordance with an embodiment of the present invention.

As shown in FIG. 5 the second reference voltage generating unit 130 uses the constant voltage CONV, which is outputted from the regulator 120, as a power supply voltage, and generates the reference voltage VREFP for generating a final target internal voltage.

The second reference voltage generating unit 130 includes a seventh PMOS transistor P7, an eighth PMOS transistor P8, a sixth NMOS transistor N6, a seventh NMOS transistor N7, a third resistor R3 and a fourth resistor R4.

The seventh PMOS transistor P7 and the eighth PMOS transistor P8 are coupled to a power supply voltage terminal, which provides the constant voltage CONV, respectively. A gate of the seventh PMOS transistor P7 and a gate of the eighth PMOS transistor P8 are commonly coupled to a drain of the eighth PMOS transistor P8. A gate and a drain of the sixth NMOS transistor N6 is commonly coupled to a drain of the seventh PMOS transistor P7 and an output terminal VREFP. A source of the sixth NMOS transistor N6 is coupled to a ground voltage VSS terminal. A gate of the seventh NMOS transistor N7 is commonly coupled to a gate of the six NMOS transistor. The third resistor R3 is coupled between the eighth PMOS transistor P8 and the seventh NMOS transistor N7. The fourth resistor R4 is coupled between the seventh NMOS transistor N7 and the ground voltage VSS terminal.

FIGS. 6A and 6B are circuit diagrams illustrating a reference voltage generating unit shown in 2 in accordance with another embodiment of the present invention.

As shown in FIGS. 6A and 6B, the reference voltage generating unit 100C includes a constant current generator 170, which includes a first reference voltage generating unit 610 and a current mirror unit 620, and a second reference voltage generating unit 630.

The first reference voltage generating unit 610 may use a threshold type reference voltage generator instead of a widlar type reference voltage generator. The first reference voltage generating unit 610 uses a high voltage VPPFB or an external high voltage VPPEXT as a power supply voltage, and includes a ninth PMOS transistor P9, an eighth NMOS transistor N8, a ninth NMOS transistor N9, a fifth resistor R5 and a sixth resistor R6.

The fifth resistor R5 is coupled between the high voltage VPPFB or VPPEXT terminal and a source of the ninth PMOS transistor P9. A gate of the ninth PMOS transistor P9 and a drain of the eighth NMOS transistor N8 are commonly coupled to the sixth resistor R6. The other end of the sixth resistor R6 is coupled to a gate of the eighth NMOS transistor N8. A source of the ninth NMOS transistor N9 and a drain of the ninth PMOS transistor P9 are commonly coupled to a ground voltage VSS terminal. A gate of the ninth NMOS transistor N9 is coupled to the high voltage VPPFB or VPPEXT terminal. A gate of the eighth NMOS transistor N8 and a source of the ninth PMOS transistor P9 are commonly coupled to an output terminal VREF.

The first reference voltage generating unit 610 uses the external high voltage VPPEXT or the high voltage VPPFB as a power supply voltage, and generates a first reference voltage VREF. The first reference voltage VREF is inputted to the current mirror unit 620.

The current mirror unit 620 includes a tenth PMOS transistor P10, an eleventh PMOS transistor P11 and a tenth NMOS transistor N10. A source of the tenth PMOS transistor P10 and a source of the eleventh PMOS transistor P11 are commonly coupled to the high voltage VPPFB or the external high voltage VPPEXT terminal. A gate of the tenth PMOS transistor P10 and a gate of the eleventh PMOS transistor P11 are commonly coupled to a drain of the tenth PMOS transistor P10. A drain of the tenth NMOS transistor N10 is coupled to a drain of the tenth PMOS transistor P10. A source of the tenth NMOS transistor is coupled to a ground voltage VSS terminal. A gate of the tenth NMOS transistor N10 receives the first reference voltage VREF outputted from the first reference voltage generating unit 610. A drain of the eleventh PMOS transistor P11 is coupled to the second reference voltage generating unit 630.

The current mirror unit 620 receives the first reference voltage VREF, generates and provides a constant current CONC to the second reference voltage generating unit 630.

The second reference voltage generating unit 630 includes a twelfth PMOS transistor P12, an eleventh NMOS transistor N11, a twelfth NMOS transistor N12, a seventh resistor R7 and an eighth resistor R8.

The seventh resistor R7 is coupled between the eleventh PMOS transistor P11 and the twelfth PMOS transistor P12, and generates a second reference voltage VREFP using the constant current CONC outputted from the current mirror unit 620.

A gate of the twelfth PMOS transistor P12 and a drain of the eleventh NMOS transistor Nil are commonly coupled to the eighth resistor R8. The other end of the eighth resistor R8 is coupled to a gate of the eleventh NMOS transistor N11. A drain of the twelfth PMOS transistor P12 and a source of the twelfth NMOS transistor N12 are commonly coupled to a ground voltage VSS terminal. A gate of the twelfth NMOS transistor N12 is coupled to the high voltage VPPFB or VPPEXT terminal. A gate of the eleventh NMOS transistor N11 and a source of the twelfth PMOS transistor P12 are commonly coupled to an output terminal VREFP.

The first reference voltage generating unit 610 and the second reference voltage generating unit 630 may use the threshold type reference voltage generator having a configuration simpler than a configuration of the widlar type reference voltage generator. The first reference voltage generating unit 610 and the second reference voltage generating unit 630 generates a final target internal voltage by generating a constant current using a current mirror unit 620 instead of the constant voltage.

As described above, in another embodiment of the present invention, the reference voltage VREFP is generated by generating a constant current using a current mirror unit instead of a regulator.

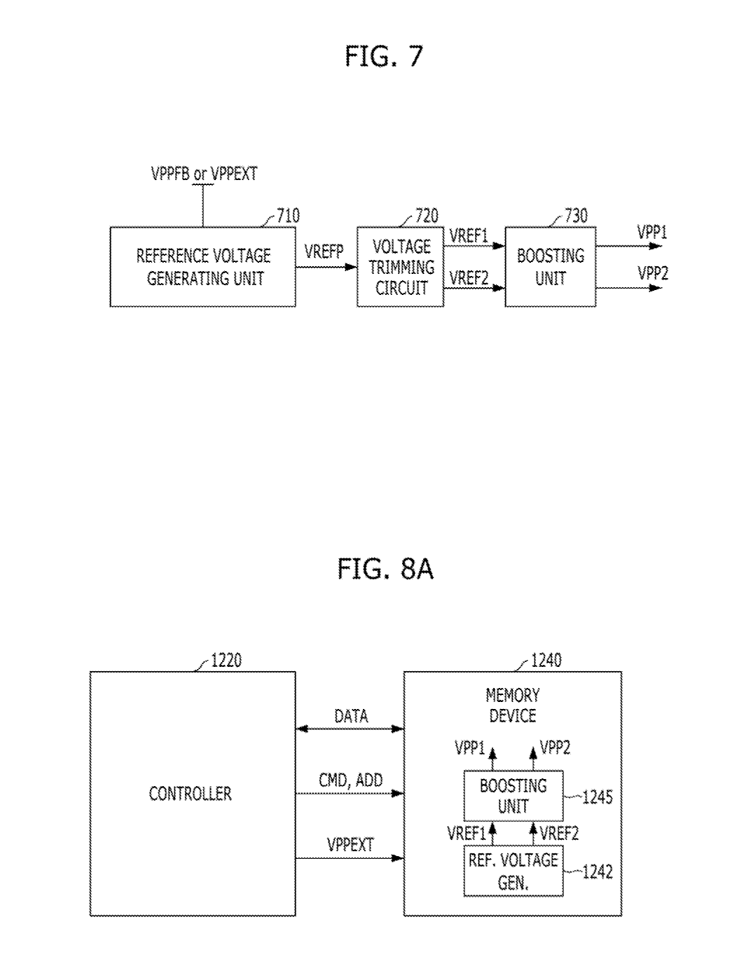

FIG. 7 is a block diagram illustrating a reference voltage generating unit for generating two reference voltages in accordance with an embodiment of the present invention.

As shown in FIG. 7, a voltage trimming circuit 720 may be connected between a reference voltage generating unit 710 and a boosting unit 730, and may provide two reference voltages VREF1 and VREF2 with a boosting unit 730. The boosting unit 730 receives two reference voltages VREF1 and VREF2 from the voltage trimming circuit 720 and generates two high voltages VPP1 and VPP2.

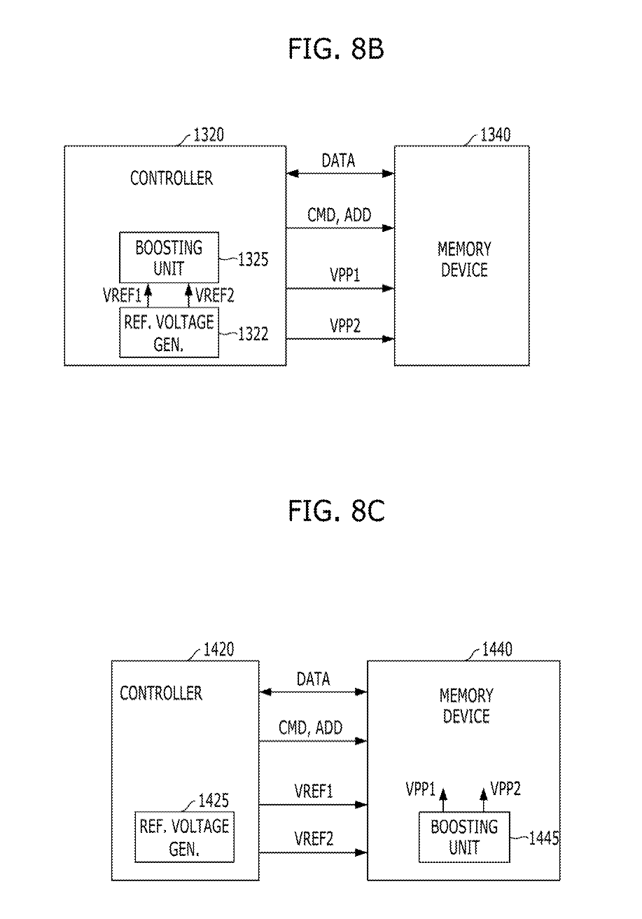

FIGS. 8A through 8C are circuit diagrams illustrating various embodiments of the present invention in a memory system including a controller and a memory device.

As shown in FIG. 8A, the memory system includes a controller 1220, a memory device 1240 that may receive data and control signals DATA, CMD and ADD from the controller 1220, a boosting unit 1245 that may output two high voltages VPP1 and VPP2, and a reference voltage generating unit 1242 that may output two reference voltages VREF1 and VREF2. In this embodiment, the boosting unit 1245 and the reference voltage generating unit 1242 are disposed in the same block as the memory device 1240. The controller 1220 provides an external high voltage VPPEXT with the reference voltage generating unit 1242.

FIG. 8B illustrates another embodiment, and the boosting unit 1325 and the reference voltage generating unit 1322 are disposed in the same block as the controller 1320. The memory device 1340 receives the high voltages VPP1 and VPP2 from the boosting unit 1325 disposed in the controller 1320.

FIG. 8C shows another embodiment, and the boosting unit 1445 is disposed in the same block as the memory device 1440, and the reference voltage generating unit 1425 is disposed in the same block as the controller 1420.

As described above, a voltage generating device in accordance with embodiments of the present invention may use the high voltage as a power supply voltage, and generate a reference voltage VREFP and an internal voltage. Thus, a minimum operation characteristic deterioration of a low voltage may be improved.

A semiconductor device in accordance with aforementioned embodiments of the present invention may be applied to a dynamic random access memory (DRAM). Furthermore, the semiconductor device may be further applied to a memory such as a static random access memory (SRAM), a flash memory, a ferroelectric random access memory (FeRAM), a magnetic random access memory (MRAM) and a phase change random access memory (PRAM).

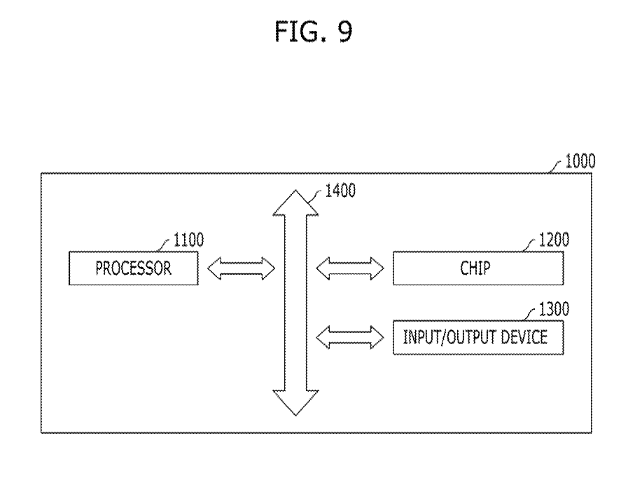

FIG. 9 is a block diagram illustrating an electronic system.

As shown in FIG. 9, the electronic system 1000 may include a processor 1100, an input/output device 1300 and a chip 1200, which performs a data communication through a bus 1400. The processor 1100 performs a program and controls the electronic system 1000. The input/output device 1300 may be used in inputting or outputting data to or from the electronic system 1000. The electronic system 1000 may be coupled to an external device, such as a personal computer or a network, and exchange data with the external device by using the input/output device 1300. The chip 1200 may store a code and data for the operation of the processor 1100 and perform an operation applied by the processor 1100. For example, the chip 1200 may include the semiconductor device having aforementioned internal voltage generating device. The electronic system 1000 may include diverse electronic control devices having the chip 1200. For example, the electronic system 1000 may be used for mobile phones, MP3 players, navigators, solid-state disk (SSD), household appliances, and the like.

While the present invention has been described with respect to the specific embodiments, it will be apparent to those skilled in the art that various changes and modifications may be made without departing from the spirit and scope of the invention as defined in the following claims.

What is claimed is:

1. A reference voltage generator, comprising:
a constant voltage generator suitable for using a high voltage as a first power supply voltage and for generating a constant voltage; and
a first reference voltage generating unit suitable for using the constant voltage as a second power supply voltage and for generating a first reference voltage.

2. The reference voltage generator of claim 1, wherein the constant voltage generator comprises a second reference voltage generating unit suitable for using the high voltage as the first power supply voltage and generating a second reference voltage; and a regulator suitable for using the high voltage as the first power supply voltage and generating the constant voltage by regulating the high voltage in response to the second reference voltage.

3. The reference voltage generator of claim 2, wherein the first reference voltage generating unit and the second reference voltage generating unit are widlar type reference voltage generators.

4. The reference voltage generator of claim 2, wherein the regulator comprises:
a differential amplifier suitable for differentially receiving the second reference voltage and a divided voltage, and outputting a determination level to a current providing unit;
a voltage dividing unit suitable for outputting the divided voltage to the differential amplifier; and
the current providing unit suitable for outputting the constant voltage in response to the determination level of the differential amplifier,
wherein the divided voltage is a half voltage of the constant voltage.

5. The reference voltage generator of claim 4, wherein the high voltage is a high voltage for a word line of a memory device.

6. The reference voltage generator of claim 5, wherein the constant voltage generator and the first reference voltage generating unit includes an initial power supplier suitable for supplying an initial powe

7. A reference voltage generator, comprising:
a constant current generator suitable for using a high voltage as a first power supply voltage and generating a constant current; and
a first reference voltage generating unit suitable for using the constant current as a power source and generating a first reference voltage.

8. The reference voltage generator of claim 7, wherein the constant current generator comprises a second reference voltage generating unit suitable for using a high voltage as a power supply voltage and generating a first reference voltage; and a current mirror unit suitable for generating a constant current in response to the first reference voltage.

9. The reference voltage generator of claim 8, the first to reference voltage generating unit and the second reference voltage generating unit are threshold type reference voltage generators.

10. The reference voltage generator of claim 8, wherein the high voltage is a high voltage for a word line of a memory chip.

11. A voltage generating system, comprising:
a reference voltage generator comprising:
a constant voltage generator suitable for using a first high voltage as a first power supply voltage and generating a constant voltage; and a first reference voltage generating unit suitable for using the constant voltage as a second power supply voltage and generating a first reference voltage; and
a boosting unit suitable for generating a second high voltage in response to the first reference voltage and the second high voltage.

12. The voltage generating system of claim 11, wherein the constant voltage generator comprises a second reference voltage generating unit suitable for using the high voltage as the first power supply voltage and generating a second reference voltage; and a regulator suitable for using the high voltage as the first power supply voltage and generating the constant voltage by regulating the high voltage in response to the second reference voltage.

13. The voltage generating system of claim 12, wherein the first high voltage is substantially the same as the second high voltage.

14. The voltage generating system of claim 12, wherein the first high voltage is supplied from an external device.

15. The voltage generating system of claim 14, wherein the external device is a controller coupled to a memory device.

16. The voltage generating system of claim 14, further comprising:
a trimming circuit disposed between the reference voltage generator and the boosting unit, and suitable for generating reference voltages equal to or more than two reference voltages.

17. A voltage generating system, comprising:
a reference voltage generator comprising:
a constant current generator suitable for using a first high voltage as a power supply voltage and generating a constant current; and a first reference voltage generating unit suitable for using the constant current as a power source and generating a first reference voltage; and
a boosting unit suitable for generating a second high voltage in response to the first reference voltage and the second high voltage.

18. The voltage generating system of claim 17, wherein the first high voltage is substantially the same as the second high voltage.

19. The voltage generating system of claim 17, wherein the first high voltage is supplied from an external device.

20. The voltage generating system of claim 19, wherein the external device is a controller coupled to a memory device.
